(19) United States
(12) Patent Application Publication
(10) Pub. No.: US 2015/0029841 A1
(43) Pub. Date: Jan. 29, 2015

(54) SYSTEM FOR SPECIFYING CAUSE OF MICROBURST OCCURRENCE AND METHOD FOR SPECIFYING CAUSE OF MICROBURST OCCURRENCE

(71) Applicant: HITACHI, LTD., Tokyo (JP)

(72) Inventors: Daigo TAKAYANAGI, Tokyo (JP); Keiji USUBA, Tokyo (JP); Yosuke TAKAHASHI, Tokyo (JP); Akihiko YOSHIDA, Tokyo (JP)

(21) Appl. No.: 14/322,138

(22) Filed: Jul. 2, 2014

(30) Foreign Application Priority Data
Jul. 25, 2013 (JP) 2013-154616

(51) Int. Cl. H04L 12/26; H04L 12/853; H04L 12/859

(52) U.S. Cl. CPC H04L 43/045; H04L 47/2475; H04L 47/2416; H04L 43/0888
USPC 370/230

(57) ABSTRACT

A microburst detection apparatus configured to detect a microburst of a control plane packet and to extract, from the control plane packet which forms the detected microburst, call information for identifying call of a data plane, a packet extraction apparatus configured to extract a data plane packet corresponding to the extracted call information, and a cause analysis apparatus configured to analyze a payload of an application layer of the extracted data plane packet, specify a service/application which causes occurrence of the microburst, count the number of data plane packets in response to the specified service/application, and display the counted number of packets associated with the specified service/application are included.

### CROSS-REFERENCE TO RELATED APPLICATION

This application claims the Japanese Patent Application No. 2013-154616 filed Jul. 25, 2013, which is incorporated herein by reference in its entirety.

### BACKGROUND OF THE INVENTION

1. Field of the Invention

The present invention relates to a technique for specifying a cause of microburst occurrence.

2. Description of the Related Art

Recently, a service of a mobile communication system which is standardized by 3GPP and called a long term evolution (LTE) system has been provided by a great number of mobile network operators and used. A standard document of the LTE is described in a 3GPP standard document (3GPP URL: http://www.3gpp.org/).

Also, recently, a technique for analyzing contents of a payload of an application layer of a data packet has been used for visualization or intrusion detection of traffic, the technique being called a deep packet inspection (DPI). An article of “Deep Packet Inspection using Parallel Bloom Filters”, by Sarang Dharmapurikar, et al., IEEE Micro, IEEE Computer Society, Volume 24, Issue 1, p. 52 to 61, January/February 2004, is related to a DPI using a Bloom filter.

### SUMMARY OF THE INVENTION

Recently, a communication system includes a broader band and higher density in housing. Thus, when communication is simultaneously started by a great number of terminals, in a communication apparatus housing the terminals at high density, a phenomenon called a microburst, in which a great number of packets reaches the communication apparatus as a burst instantly, occurs. The reason why communication is started simultaneously by a great number of terminals is that the great number of terminals use a specific service/application which automatically causes communication at predetermined time.

Since communication is started from a call control of a control plane, a control plane packet becomes a microburst in most cases.

When receiving microbursts exceeding a throughput, a communication apparatus deals by performing shaping, policing, and packet discarding of a packet flow, but a delay or discarding of a packet caused thereby causes lower service quality. Thus, it is necessary for a communication operator to provide an essential solution.

As one of the essential solutions, there is a method to prevent packets from being congested and becoming the microburst by improving the throughput of the communication apparatus to process the microburst without performing delaying or discarding, or by expanding the communication apparatus to perform distributed processing. However, in a case where traffic volume of the microburst is dozens of times of that of a normal time, a great part of the throughput becomes idle in normal traffic processing. Thus, the improvement of the throughput or the expansion of the communication apparatus is not a realistic method. A different method to specify a cause of microburst occurrence and to ask a service/application providing operator for an improvement to prevent a microburst due to the same cause is a realistic method.

However, to specify the cause of microburst occurrence, statistical data or a call control log of the traffic volume included by a prior communication apparatus is not adequate. It is because the statistical data or the call control log of the traffic volume does not include information of “what service/application has caused traffic?” which is necessary in analyzing the cause of microburst occurrence, although the statistical data or the call control log of the traffic volume includes information of “when which call control has become a microburst”. This information is in a payload in an application layer of a data plane packet during microburst occurrence.

As a method to specify a service/application by analyzing contents of a payload of an application layer, there is the DPI technique such as an example in an article of “Deep Packet Inspection using Parallel Bloom Filters”, by Sarang Dharmapurikar, et al., IEEE Micro, IEEE Computer Society, Volume 24, Issue 1, p. 52 to 61, January/February 2004. However, there has been no mechanism to detect microburst occurrence and to extract and analyze a data plane packet related to the microburst.

Thus, to specify a cause of microburst occurrence, a new mechanism to extract and analyze a data plane packet corresponding to the microburst.

In a system to specify a cause of burst occurrence by using a microburst detection apparatus, a packet extraction apparatus, and a cause analysis apparatus, each of the apparatuses operates in the following manner. The microburst detection apparatus detects a microburst of a control plane packet and extracts, from the control plane packet which forms the detected microburst, call information for identifying call of a data plane. The packet extraction apparatus extracts a data plane packet corresponding to the call information extracted by the microburst detection apparatus. The cause analysis apparatus analyzes a payload of an application layer of the data plane packet extracted by the packet extraction apparatus and specifies a service/application which causes microburst occurrence. Then, the cause analysis apparatus counts the number of data plane packets in response to the specified service/application and displays the counted number of packets associated with the specified service/application.

According to the present invention, it is possible to specify a cause of microburst occurrence.

### BRIEF DESCRIPTION OF THE DRAWINGS

FIG. 1 is a configuration view of an LTE system;

FIG. 2 is a brief sequence diagram of Reactivation;

FIG. 3 is a configuration view of an LTE system of a first embodiment;

FIG. 4 is an operation sequence diagram of the first embodiment;

FIG. 5 is a view illustrating contents preset into a microburst detection apparatus;

FIG. 6 is an operation flowchart of a microburst detection apparatus of the first embodiment;

FIG. 7 is a view illustrating contents of a packet extraction instruction;

FIG. 8 is an operation flowchart of a packet extraction apparatus of the first embodiment;

FIG. 9 is an operation flowchart of a cause analysis apparatus;

FIG. 10 is a chart of an example of contents displayed by the cause analysis apparatus;

FIG. 11 is a configuration view of an LTE system of a second embodiment;

FIG. 12 is an operation sequence diagram of the second embodiment;

FIG. 13 is an operation flowchart of a microburst detection apparatus of the second embodiment;

FIG. 14 is an example of a call information correspondence table of the second embodiment;

FIG. 15 is an operation flowchart of a packet extraction apparatus of the second embodiment;

FIG. 16 is a configuration view of an LTE system of a third embodiment;

FIG. 17 is a configuration view of an LTE system of a fourth embodiment;

FIG. 18 is a configuration view of an LTE system of a fifth embodiment;

FIG. 19 is a configuration view of a microburst detection apparatus;

FIG. 20 is a configuration view of a packet extraction apparatus;

FIG. 21 is a configuration view of a cause analysis apparatus; and

FIG. 22 is a configuration view of a call information management apparatus.

### DESCRIPTION OF THE PREFERRED EMBODIMENTS

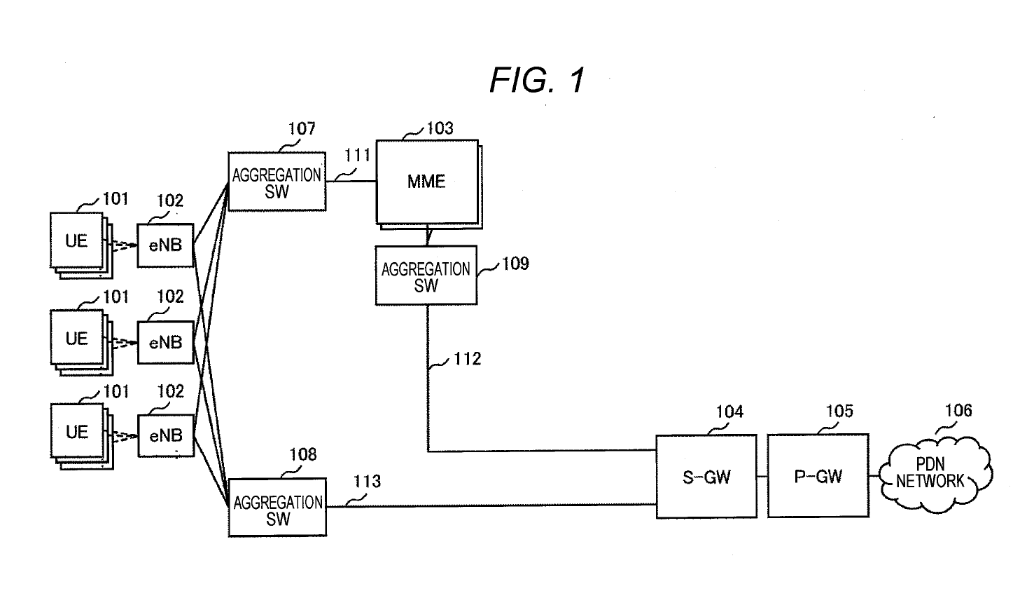

First, microburst occurrence will be described along with a configuration of an LTE system. In FIG. 1, a configuration view of an LTE system is illustrated. A UE 101 is a radio terminal. An eNB 102 is a radio base station. An MME 103 is a call control apparatus. Each of an S-GW 104 and a P-GW 105 is a gateway to perform data packet transfer. A PDN network 106 is a public data network. In a communication path 111, a control plane (C-Plane) packet including a call control message between the UE 101 or the eNB 102 and the MME 103 flows, the communication path 111 being called S1-MME. Communication paths from a plurality of UEs 101 or eNBs 102 to the MME 103 are aggregated to the communication path S1-MME (111) by an aggregation SW 107. In a communication path 112, a C-Plane packet including a call control message between the MME 103 and the S-GW 104 flows, the communication path 112 being called S11. Communication paths from a plurality of MMES 103 to the S-GW 104 are aggregated to the S11 (112) through an aggregation SW 109. In a communication path 113, in which a user plane (U-Plane) packet including user data between the UE 101 or the eNB 102 and the S-GW 104 flows, the communication path 113 being called an S1-U. Communication paths from the plurality of UEs 101 or eNBs 102 to the S-GW 104 are aggregated to the communication path S1-U (113) by an aggregation SW 108.

Here, for description in the following, a data channel called a bearer in the S1-U (113) and an identifier TEID thereof will be described. To make a U-Plane packet flow in the S1-U (113), it is necessary to establish a data channel called a bearer in the S1-U (113). The bearers vary from one UE 101 to another. Also, one UE 101 may use a plurality of bearers. Also, an Uplink bearer and a Downlink bearer are different from each other. The bearer is identified by an identifier called a TEID.

The S-GW 104 delivers and transmits an Uplink TEID to the eNB 102 through the MME 103, whereby the Uplink bearer is established. An Uplink TEID delivered by the S-GW 104 is unique in one S-GW 104. Thus, to identify Uplink bearers of a plurality of S-GWs 104 uniquely, it is necessary to make an IP address and an Uplink TEID of the S-GW 104 a set (pair). As an identifier which is a set of an IP address and an Uplink TEID of the S-GW 104, there is an S1-U SGW F-TEID.

Similarly, the eNB 102 delivers and transmits a Downlink TEID to the S-GW 104 through the MME 103, whereby the Downlink bearer is established. A Downlink TEID delivered by the eNB 102 is unique in one eNB 102. Thus, to identify Downlink bearers of a plurality of eNBs 102 uniquely, it is necessary to make an IP address and a Downlink TEID of the eNB 102 a set (pair). As an identifier which is a set of an IP address and a Downlink TEID of the eNB 102, there is an S1 eNodeB F-TEID.

In the LTE system, when the UE 101 has been in a non-communication state for more than a predetermined period of time, a bearer in the S1-U (113) is released. Thus, when the UE 101 starts communication, call control called Reactivation to reestablish a bearer in the S1-U (113) is performed. That is, when a great number of radio terminal UEs 101 use a specific service/application which causes communication at certain time (time determined by specific service/application), the Reactivation occurs from the great number of UEs 101 simultaneously at the certain time.

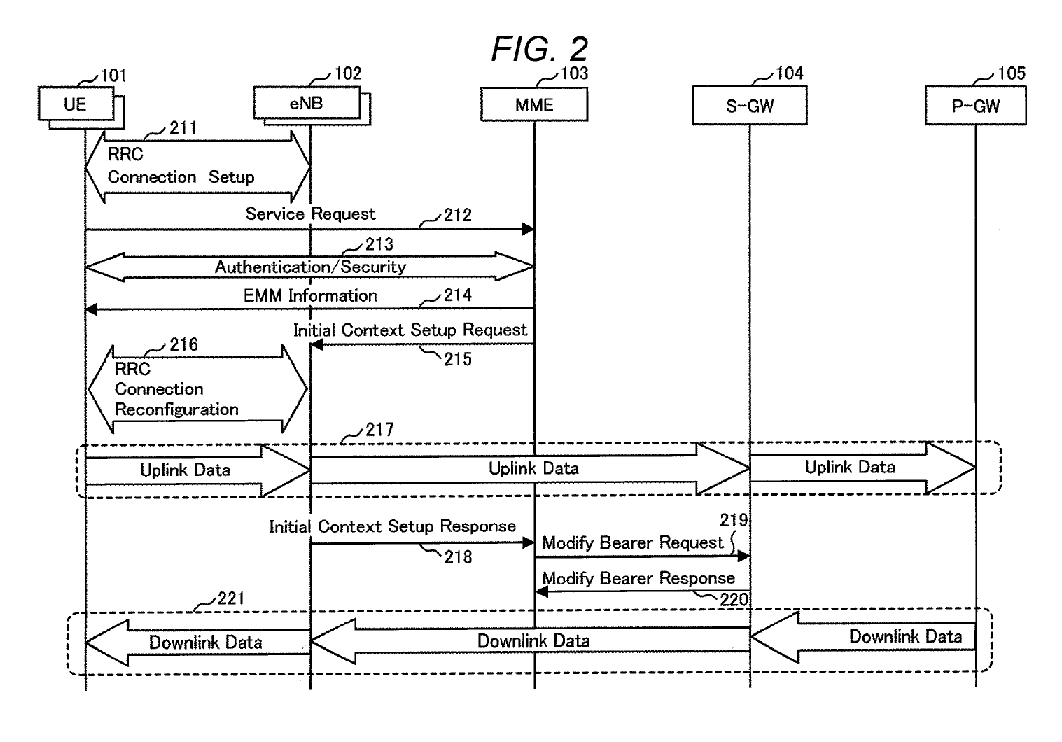

In FIG. 2, a brief sequence diagram of the Reactivation is illustrated. With reference to FIG. 2, a flow of the Reactivation, and where a microburst exceeding a throughput may occur will be described. A radio resource control (RRC) Connection Setup processing (211) to establish a connection of a radio section between the UE 101 and the eNB 102 is executed. A radio communication between the UE 101 and the eNB 102 is executed in exact radio communication resource allocation. Thus, the eNB 102 does not receive, from the UE 101, the microburst exceeding the throughput.

When the connection of the radio section between the UE 101 and the eNB 102 is established, the UE 101 transmits, to the MME 103, a call control message called a Service Request (212) through the eNB 102. A stream control transmission protocol (SCTP) is used as a protocol for communication of the S1-MME (111) between the eNB 102 and the MME 103. Thus, the MME 103 does not receive, from the eNB 102, a microburst exceeding the throughput.

In response to the reception of the Service Request (212) by the MME 103, Authentication/Security processing (213) is executed between the UE 101 and the MME 103 and EMM Information (214) is transmitted from the MME 103 to the UE 101.

When the MME 103 transmits an Initial Context Setup Request (215) to the eNB 102, RRC Connection Reconfiguration processing (216) is executed between the eNB 102 and the UE 101. The Initial Context Setup Request (215) includes an IP address and an Uplink TEID of the S-GW 104. Thus, by using the IP address and the Uplink TEID of the S-GW 104, the eNB 102 can transfer Uplink Data (217), which is transmitted from the UE 101, to the S-GW 104 through the S1-U (113). (Since the Uplink TEID delivered from the S-GW 104 is also notified to the MME 103 in advance when the UE 101 establishes a session with the S-GW 104, the MME 103 transmits, to the eNB 102, the Initial Context Setup Request (215) including the Uplink TEID in the Reactivation.)

Next, when an Initial Context Setup Response (218) is transmitted back from the eNB 102 to the MME 103, the MME 103 transmits a Modify Bearer Request (219) to the S-GW 104. A user datagram protocol (UDP) is used for communication of the S11 (112) between the MME 103 and the S-GW 104 Thus, this Modify Bearer Request (219) may become a microburst which exceeds the throughput.

The Modify Bearer Request (219) includes the S1 eNodeB F-TEID which is a Downlink identifier. Thus, by using the S1 eNodeB F-TEID, the S-GW 104 can transfer Downlink Data (221), which moves to the UE 101, to the eNB 102 through the S1-U (113). Also, the S-GW 104 transmits a Modify Bearer Response (220) back to the MME 103.

What has been described above is a flow of the Reactivation. It has been described that the Modify Bearer Request (219) in the S11 (112) may become a microburst which exceeds the throughput.

### First Embodiment

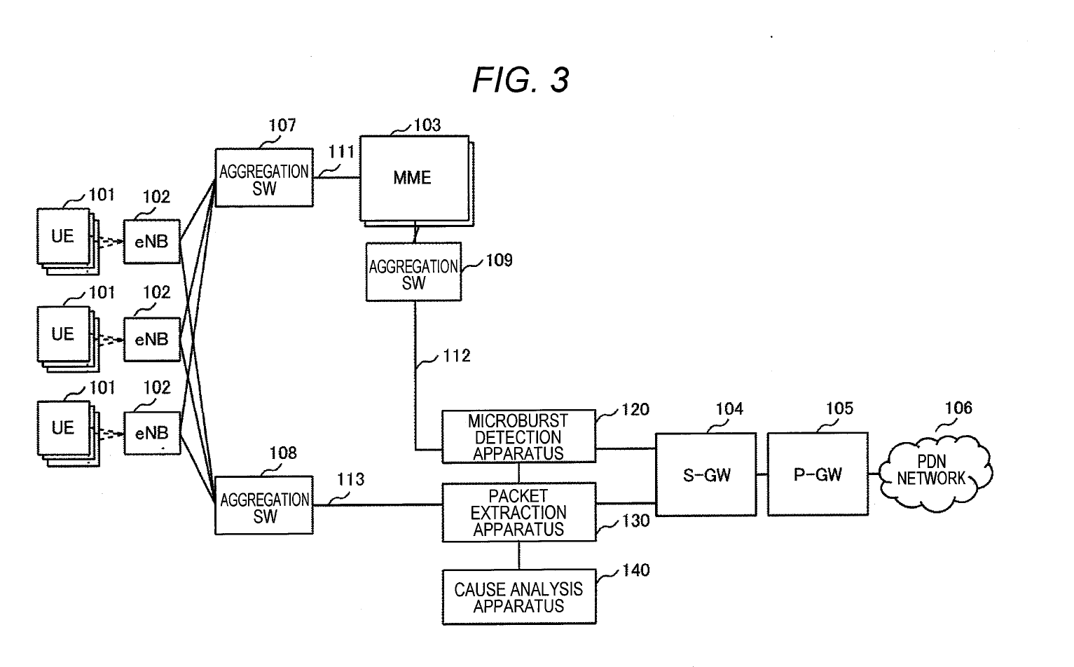

A mechanism to specify a cause of microburst occurrence in a case where a Modify Bearer Request (219) becomes the microburst will be described. In FIG. 3, a system configuration view of an LTE system of the present embodiment is illustrated. A point different from the system configuration in FIG. 1 will be described mainly.

To detect a microburst of the Modify Bearer Request (219) in S11 (112), a microburst detection apparatus 120 is placed. Also, to extract a U-Plane packet flowing in S1-U (113), a packet extraction apparatus 130 is placed and connected to the microburst detection apparatus 120. Also, a cause analysis apparatus 140 is placed and connected to the packet extraction apparatus 130. By an eNB 102, an MME 103, and an S-GW 104, each of the microburst detection apparatus 120 and the packet extraction apparatus 130 is not recognized as an apparatus to be communicated but is recognized simply as a communication path. Thus, the LTE system operates in such a manner described with reference to FIG. 2.

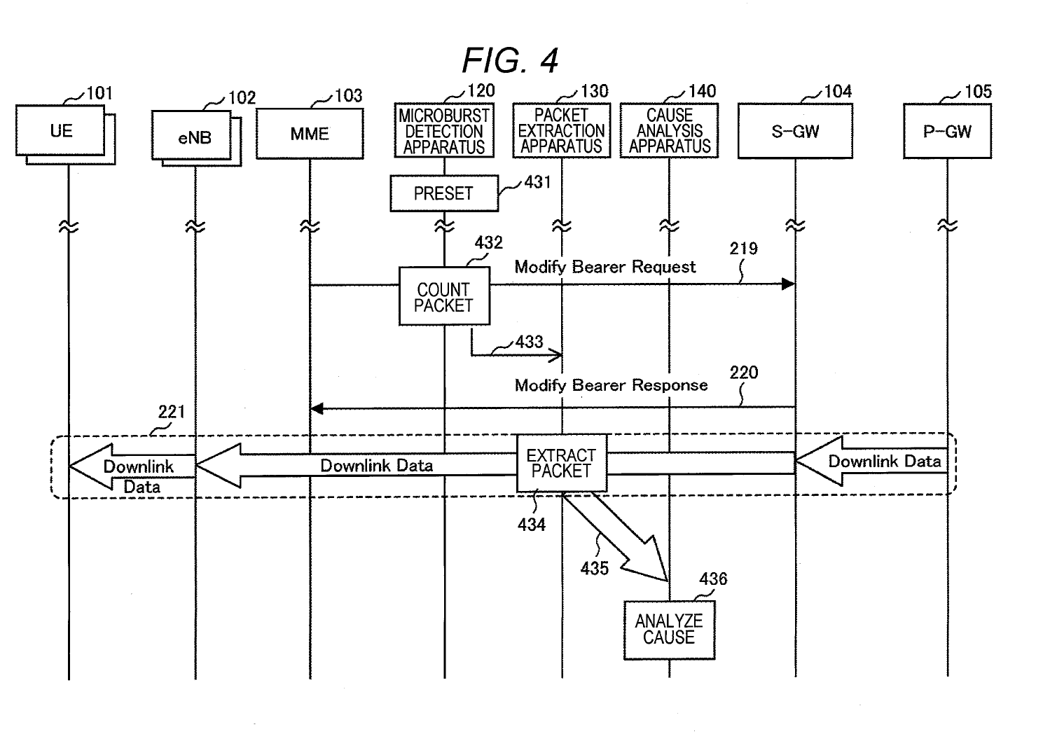

An operation of the LTE system illustrated in FIG. 3 will be described along a sequence diagram in FIG. 4. In FIGS. 4, 211 to 218 of the sequence diagram in FIG. 2 are omitted.

The microburst detection apparatus 120 is preset (431) to count the number of received packets including the Modify Bearer Request (219) in each cycle of predetermined duration and to determine a microburst in a case where a count value in one cycle becomes equal to or greater than a threshold, and to extract call information for identifying call of a U-Plane according to information in the packet including the Modify Bearer Request (219).

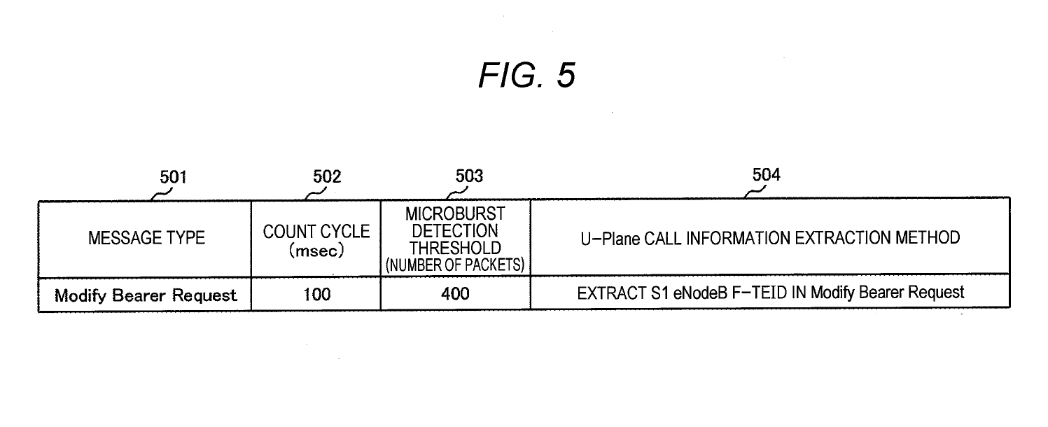

In FIG. 5, contents preset (431) into the microburst detection apparatus 120 are illustrated. A message type 501 indicates which message is to be counted. A count cycle 502 indicates a cycle to count the number of received packets of the message type 501. A microburst detection threshold 503 is a threshold to determine that the received packet of the message type 501 is a microburst, and is a threshold of a count value in one cycle. A U-Plane call information extraction method 504 indicates what is extracted as call information to identify call of a U-Plane according to information in the packet of the message type 501.

Here, it is assumed that the microburst detection apparatus 120 is preset in a manner illustrated in FIG. 5. Thus, the microburst detection apparatus 120 extracts an S1 eNodeB F-TEID from a packet including a Modify Bearer Request (219) as the message type 501. Also, the microburst detection apparatus 120 determines a microburst in a case where 400 or more packets of the Modify Bearer Request (219) are counted in 100 ms.

When the microburst detection apparatus 120 detects the Modify Bearer Request (219), the microburst detection apparatus 120 follows the setting illustrated in FIG. 5, extracts the S1 eNodeB F-TEID from the packet of the Modify Bearer Request (219) and counts the number of extracted packets (432).

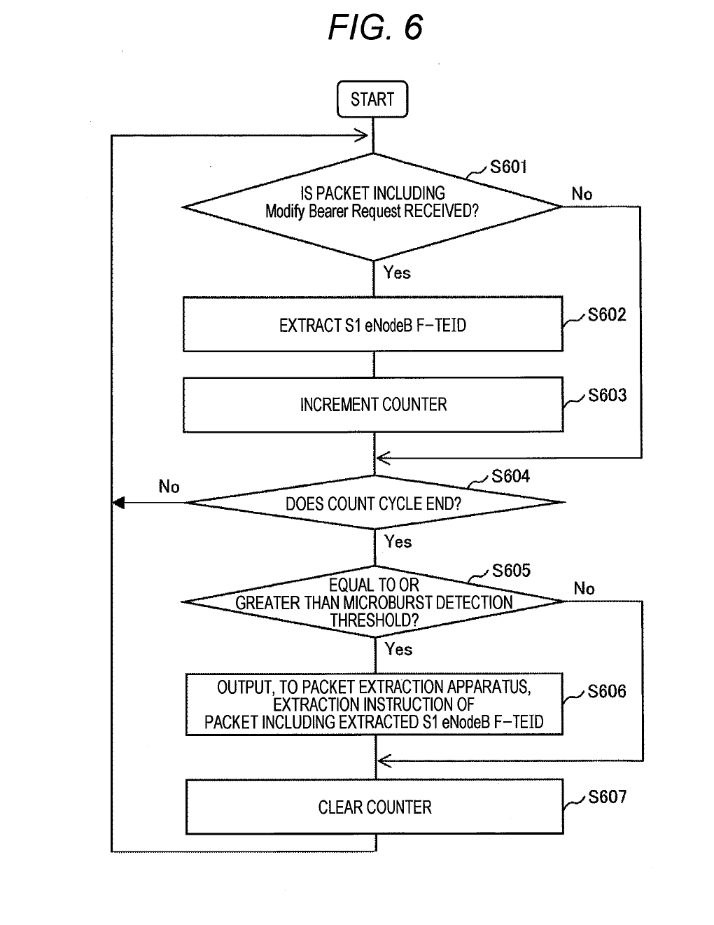

In FIG. 6, a flowchart of an operation of extracting the S1 eNodeB F-TEID and counting the number of packets (432 in FIG. 4) by the microburst detection apparatus 120 is illustrated. This operation is started in response to an end of the presetting into the microburst detection apparatus 120. When receiving a packet including the Modify Bearer Request (219) (S601), the microburst detection apparatus 120 extracts the S1 eNodeB F-TEID and stores the extracted S1 eNodeB F-TEID (S602) and counts the number of packets (S603). The microburst detection apparatus 120 repeats S601 to S603 until the count cycle 502 is reached (S604) and determines whether a count value is equal to or greater than the microburst detection threshold 503 when the count cycle 502 is reached (S605). Here, it is assumed that the count value in 100 ms is 500. Since the count value is greater than the microburst detection threshold 503 which is 400 packets, the microburst detection apparatus 120 determines a microburst, transmits a packet extraction instruction including the extracted S1 eNodeB F-TEID to the packet extraction apparatus 130 (S606, 433 in FIG. 4), clears a counter (S607) and goes back to S601.

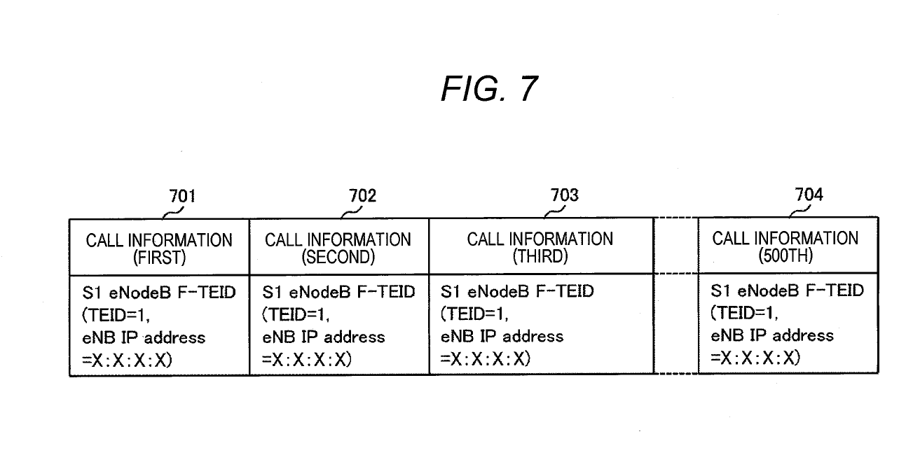

In FIG. 7, contents of the packet extraction instruction transmitted from the microburst detection apparatus 120 to the packet extraction apparatus 130 are illustrated. The packet extraction instruction includes the extracted number of pieces of call information 701 to 704. Here, it is assumed that the microburst detection apparatus 120 transmits, to the packet extraction apparatus 130, a packet extraction instruction (433) illustrated in FIG. 7. As illustrated in 701 to 704, the packet extraction instruction includes 500 S1 eNodeB F-TEIDs extracted and stored in S602 in FIG. 6.

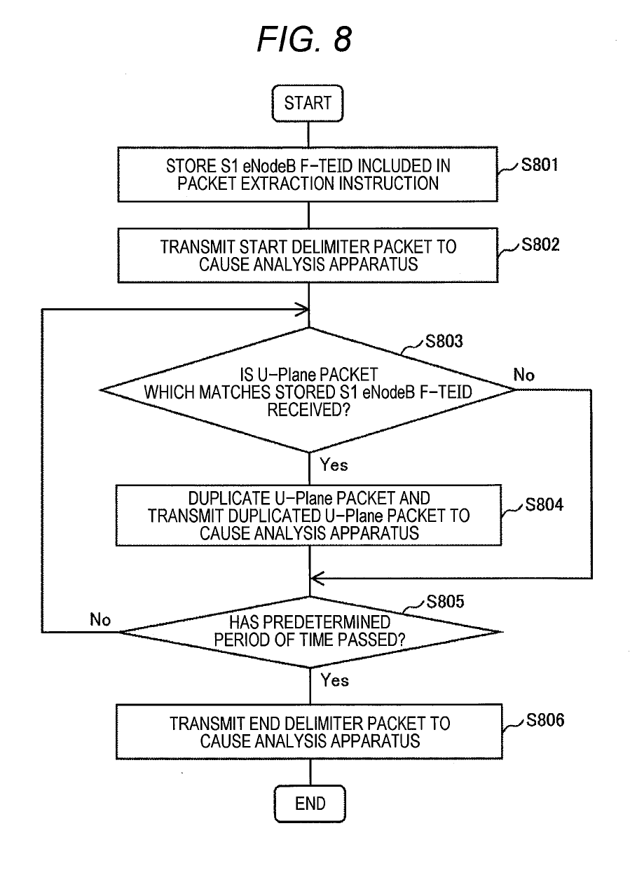

Next, an operation (434 in FIG. 4) of the packet extraction apparatus 130 which has received the packet extraction instruction of S606 in FIG. 6 will be described with reference to a flowchart illustrated in FIG. 8. In response to the reception of the packet extraction instruction, the packet extraction apparatus 130 executes the operation in the flowchart in FIG. 8. The packet extraction apparatus 130 stores the S1 eNodeB F-TEID included in the received packet extraction instruction (S801). The packet extraction apparatus 130 transmits a start delimiter packet which tells the cause analysis apparatus 140 to start packet extraction (S802). The packet extraction apparatus 130 monitors a destination IP address of an IP header and a destination TEID of a GTPv2-C header of a U-Plane packet. When receiving a U-Plane packet which matches the IP address and the Downlink TEID of the eNB 102 included in the S1 eNodeB F-TEID stored in S800 (S803), the packet extraction apparatus 130 duplicates the U-Plane packet and transmits the duplicated U-Plane packet to the cause analysis apparatus 140 (S804, 435 in FIG. 4). S803 and S804 are repeated until a predetermined period of time passes. When the predetermined period of time has passed (S805), an end delimiter packet to tell the cause analysis apparatus 140 to end the packet extraction is transmitted (S806) and the processing ends.

In 435 in FIG. 4, it is illustrated that the packet extraction apparatus 130 transmits the start delimiter packet, the extracted U-Plane packet, and the end delimiter packet to the cause analysis apparatus 140.

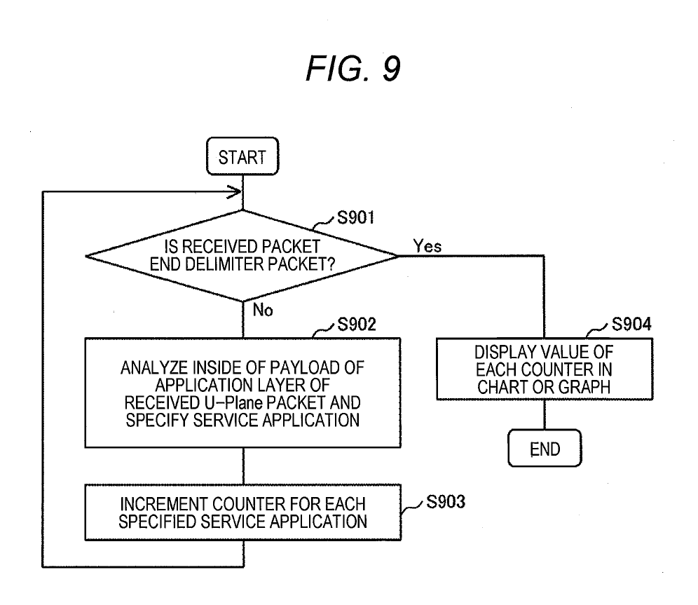

Next, an operation (436 in FIG. 4) of the cause analysis apparatus 140 which has received the packet of 435 in FIG. 4 will be described with reference to a flowchart in FIG. 9. In response to the reception of the start delimiter packet from the packet extraction apparatus 130, the cause analysis apparatus 140 starts operating. When a received packet is not the end delimiter packet (S901), the received packet is a U-Plane packet. Thus, the cause analysis apparatus 140 analyzes the inside of a payload of an application layer of the received U-Plane packet and specifies a service/application (S902), increments a counter corresponding to the specified service/application (S903), and goes back to S901. When the received packet is the end delimiter packet (S901), the cause analysis apparatus 140 displays, in a chart or a graph on a display apparatus, a value of each counter for each service/application (S904) and ends the processing.

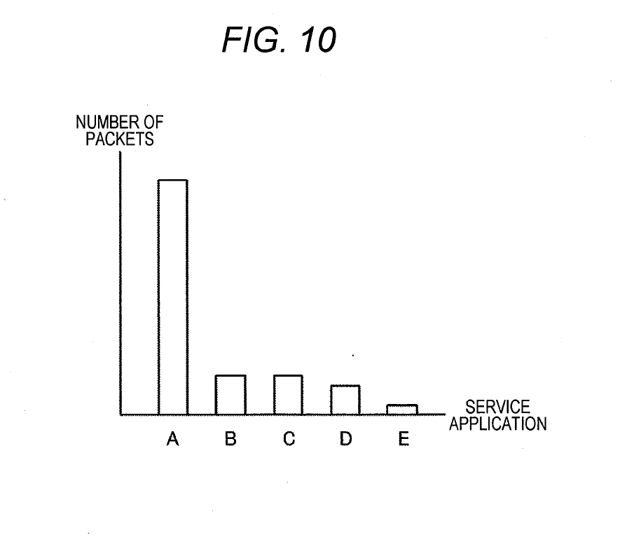

For example, when a result in the display contents by S904 is in such a manner illustrated in FIG. 10, a maintainer who sees the display contents can recognize that a service/application A is the cause of microburst occurrence and can ask an operator providing the service/application A for an improvement such as spreading timing of communication occurrence.

In the present embodiment, it is illustrated that a Downlink Data packet which flows after occurrence of a microburst of a Modify Bearer Request is extracted as a U-Plane packet which is a material to specify a service/application which is a cause of the microburst occurrence, and the service/application which causes the microburst occurrence is specified from an analysis of the extracted Downlink Data packet.

### Second Embodiment

In the present embodiment, an Uplink Data packet which starts flowing before occurrence of a microburst of a Modify Bearer Request (219) is extracted as a U-Plane packet which is a material to specify a service/application which causes the microburst occurrence. Therefore, a packet extraction apparatus accumulates packets in a predetermined period of time. Also, the packet extraction apparatus extracts call information for identifying call of corresponding Uplink Data according to information in the Modify Bearer Request (219).

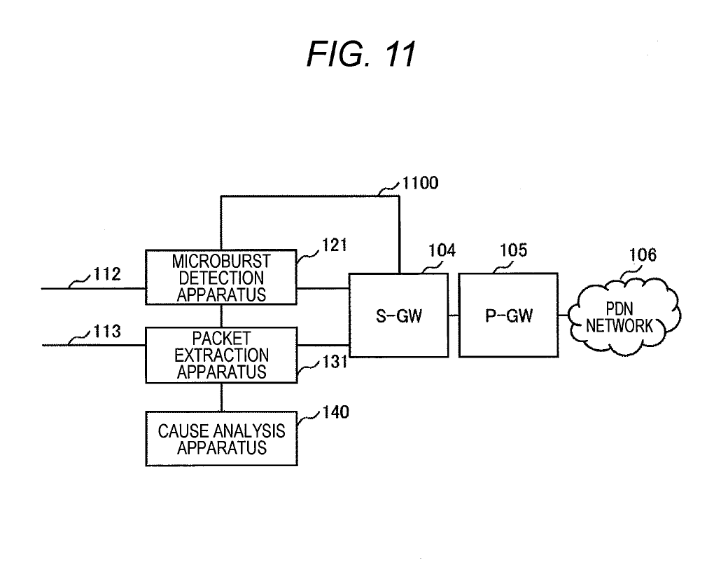

In FIG. 11, a configuration view of an LTE system of the present embodiment is illustrated. In FIG. 11, a point different from the system configuration of the first embodiment in FIG. 3 will be described mainly. As described later, in the LTE system of the present embodiment, an interface 1100, with which a microburst detection apparatus 121 acquires a call information correspondence table from an S-GW 104, is provided. A connection relationship of the microburst detection apparatus 121 and a packet extraction apparatus 131 to other apparatuses is in a manner similar to that of the system configuration of the first embodiment in FIG. 3. However, an operation of each of the microburst detection apparatus 121 and the packet extraction apparatus 131 is different from that of the first embodiment, and thus, a reference sign thereof is changed.

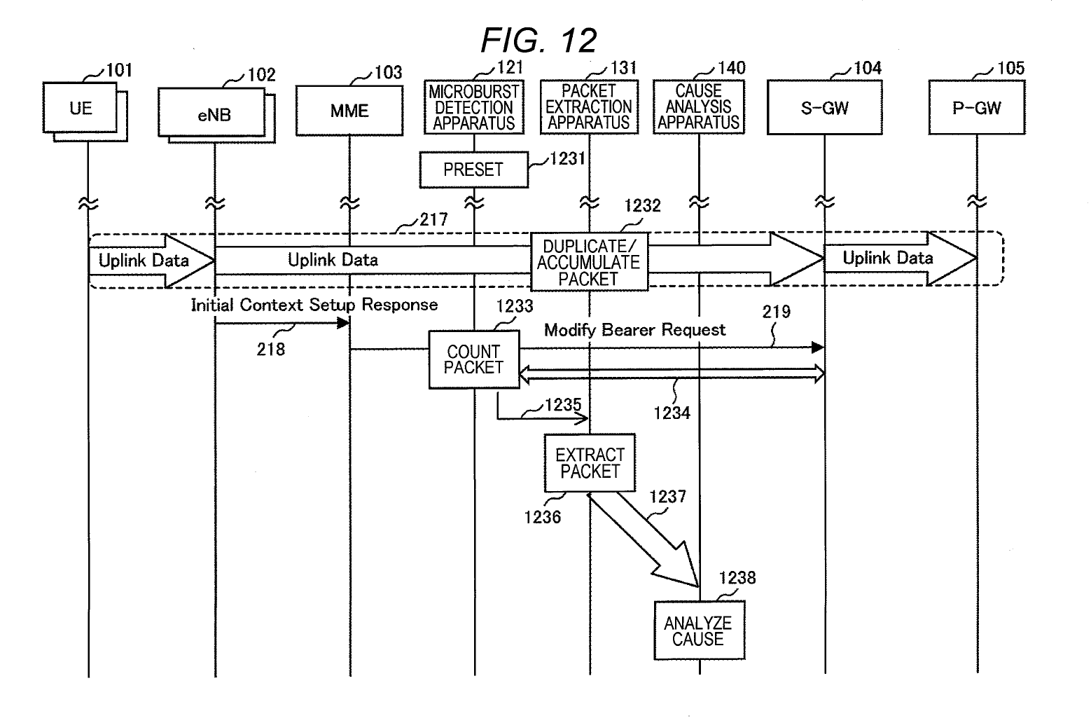

An operation in a system configuration in FIG. 11 will be described along a sequence diagram in FIG. 12. In FIGS. 12, 211 to 216 and 220 to 221 of the sequence diagram in FIG. 2 are omitted. Description of a sequence which has been described with reference to FIG. 2 or FIG. 4 is omitted and a different point will be described mainly. Similarly to the first embodiment, the microburst detection apparatus 121 is preset (1231 in FIG. 12). Items set into the microburst detection apparatus 121 is similar to that of the first embodiment illustrated in FIG. 5. However, to a U-Plane call information extraction method (504), it is preset to extract a destination IP address of an IP header and a destination TEID of a GTPv2-C header of a packet of the Modify Bearer Request (219) and to extract an S1-U SGW F-TEID corresponding to the extracted destination IP address and destination TEID from a call information correspondence table which will be described later, when a microburst is determined.

Although it is not illustrated, when executing a call control sequence, such as Initial Attach, Tracking Area Update with S-GW change, Handover with S-GW change, Dedicated Bearer Activation, and Dedicated Bearer Deactivation, as an original operation, the S-GW 104 stores a correspondence relationship between an F-TEID for a C-Plane delivered from the S-GW 104 to the MME 103 and an S1-U SGW F-TEID delivered from the S-GW 104 to an eNB 102. Here, this stored correspondence relationship is called a call information correspondence table.

The packet extraction apparatus 131 duplicates a packet of Uplink Data 217 and accumulates the duplicated packet (1232 in FIG. 12). The duplicated packet is accumulated until processing of 1237 in FIG. 12 which will be described later is completed.

When detecting the Modify Bearer Request (219), the microburst detection apparatus 121 follows the contents of presetting, extracts a destination IP address and a destination TEID from a packet of the Modify Bearer Request (219), and counts the number of extracted packets (1233 in FIG. 12).

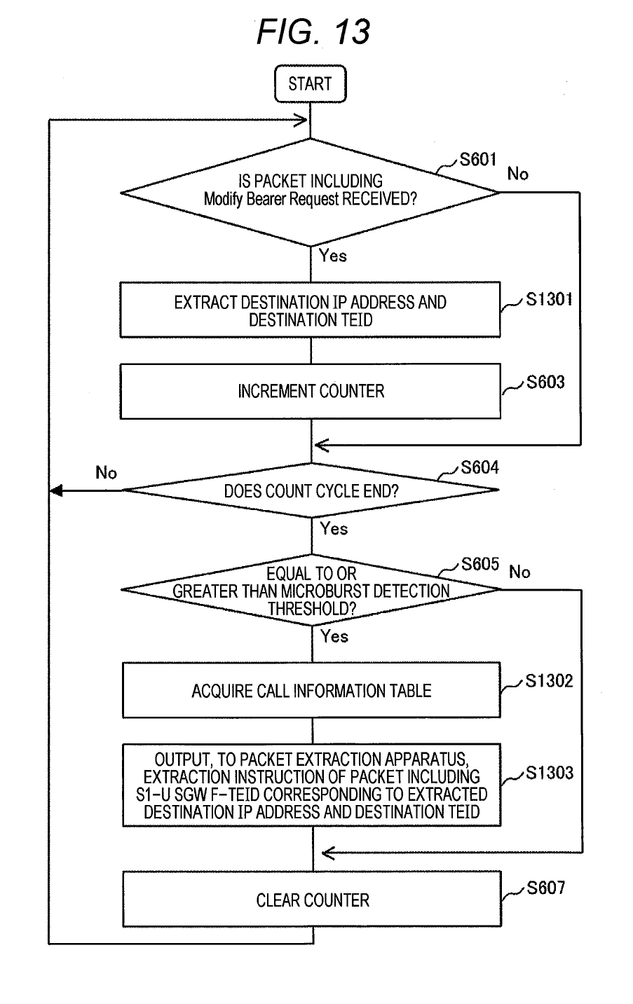

In FIG. 13, a flowchart of an operation of extracting a destination IP address and a destination TEID and counting the number of packets (1233 in FIG. 12) by the microburst detection apparatus 121 is illustrated. In the operation illustrated in FIG. 13, S1301 is executed instead of S602 and S1302 and S1303 are executed instead of S606, S602 and S606 being processing of the first embodiment illustrated in FIG. 6. When receiving a packet including the Modify Bearer Request (S601), the microburst detection apparatus 121 extracts a destination IP address in the IP header and a destination TEID in the GTPv2-C header and stores the extracted destination IP address and destination TEID (S1301). Also, when determining a microburst (S605), the microburst detection apparatus 121 acquires a call information correspondence table from the S-GW 104 (S1302, 1234 in FIG. 12).

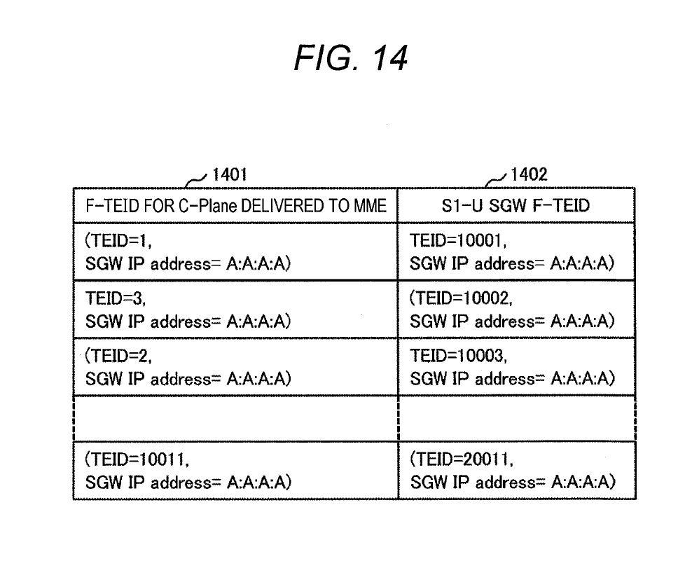

In FIG. 14, an example of the call information correspondence table is illustrated. In the call information correspondence table, an “F-TEID for C-Plane delivered to MME” 1401 and an “S1-U SGW F-TEID” 1402 are associated with each other and stored.

Here, description goes back to FIG. 13. The microburst detection apparatus 121 searches a column of the “F-TEID for C-Plane delivered to MME” (1401) in the call information correspondence table for the one including an IP address and a TEID which match a destination IP address and a destination TEID of each set extracted in S1301, and extracts an S1-U SGW F-TEID (1402) corresponding thereto. Then, the microburst detection apparatus 121 transmits a packet extraction instruction including those S1-U SGW F-TEIDs to the packet extraction apparatus 131 (S1303, 1235 in FIG. 12). Although it is not illustrated, the packet extraction instruction includes 500 S1-U SGW F-TEIDs corresponding to the 500 sets of destination IP address and destination TEID extracted in S1301 in FIG. 13. Other operations in FIG. 13 are in a manner similar to those in the contents described with reference to FIG. 6.

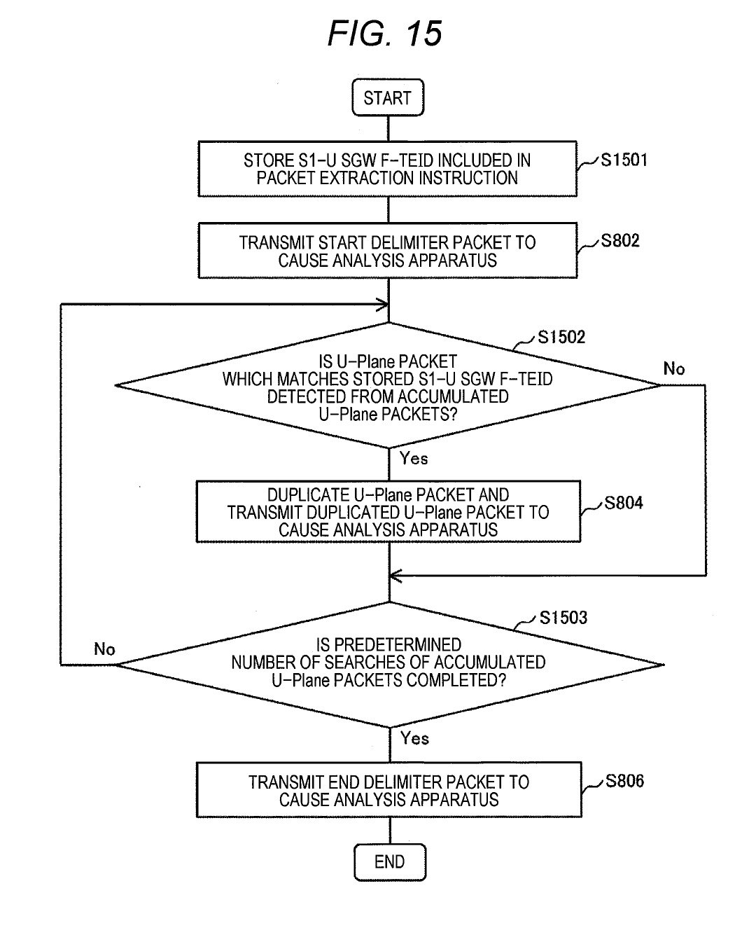

An operation (1236 in FIG. 12) of the packet extraction apparatus 131 which has received the packet extraction instruction (1235 in FIG. 12) will be described with reference to an operation flowchart illustrated in FIG. 15. In the operation illustrated in FIG. 15, S1501 is executed instead of S801, S1502 is executed instead of S803, and S1503 is executed instead of S805, S801, S803, and S805 being processing of the first embodiment illustrated in FIG. 8. The packet extraction apparatus 131 stores the S1-U SGW F-TEIDs included in the received packet extraction instruction (1235 in FIG. 12) (S1501). When detecting, from the accumulated U-Plane packets (1232 in FIG. 12), a U-Plane packet including a destination IP address of the IP header and a destination TEID of the GTPv2-C header respectively matching an IP address and an Uplink TEID, which are included in the stored S1-U SGW F-TEIDs, of the S-GW 104 (S1502), the packet extraction apparatus 131 duplicates the packet and transmits the duplicated packet to the cause analysis apparatus 140 (S804, 1237 in FIG. 12). S1502 and S804 are repeated until a predetermined number of searches are completed (S1503).

An operation of the cause analysis apparatus 140 (1238 in FIG. 12) is in a manner similar to the operation of 436 in FIG. 4 in the first embodiment, that is, the operation of the flowchart in FIG. 9.

As a result of the processing by the cause analysis apparatus 140, a result similar to that in FIG. 10 of the first embodiment is acquired. Thus, a maintainer can recognize a service/application which is the cause of microburst occurrence and can ask an operator providing the service/application for an improvement such as spreading timing of communication occurrence.

### Third Embodiment

The present embodiment is a modified example of the second embodiment. In the second embodiment, the interface for acquiring a call information correspondence table is connected to the S-GW 104. In the second embodiment, the S-GW 104 creates a call information correspondence table by an original operation thereof and outputs the call information correspondence table to the microburst detection apparatus 121 in response to a request from the microburst detection apparatus 121. In the present embodiment, a call information management apparatus is introduced on the assumption of a case where a microburst detection apparatus 121 cannot acquire a call information correspondence table from an S-GW 104.

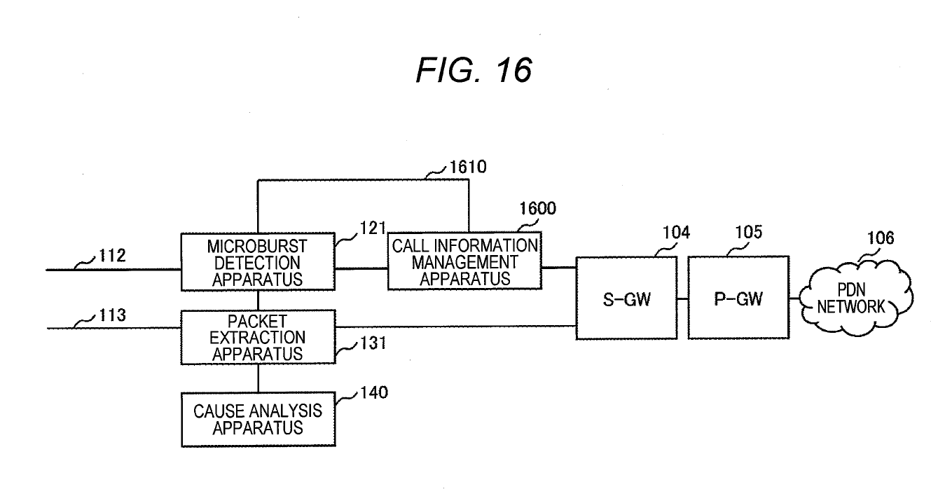

In FIG. 16, a configuration of an LTE system of the present embodiment is illustrated in comparison with the system configuration of the second embodiment illustrated in FIG. 11. In the configuration of the LTE system of the present embodiment, a call information management apparatus 1600 is placed in S11 (112) to monitor a C-Plane packet in the S11 (112) and to create/manage a call information correspondence table. The microburst detection apparatus 121 is connected to the call information management apparatus 1600 via an interface 1610 to acquire the call information correspondence table from the call information management apparatus 1600. An operational difference between the present embodiment and the second embodiment is that the microburst detection apparatus 121 acquires the call information correspondence table from the call information management apparatus 1600 instead of acquiring from the S-GW 104 in the present embodiment.

As it has been described as the operation of the S-GW 104 in the second embodiment, the call information management apparatus 1600 monitors a message of the S11 (112) during a call control sequence such as Initial Attach, Tracking Area Update with S-GW change, Handover with S-GW change, Dedicated Bearer Activation, and Dedicated Bearer Deactivation, and stores, into the call information correspondence table, a correspondence relationship between an F-TEID for a C-Plane delivered from the S-GW 104 to an MME 103 and an S1-U SGW F-TEID delivered from the S-GW 104 to an eNB 102. Detail description of the operation of the call information management apparatus 1600 is omitted since the operation thereof is realized as the operation of the existing S-GW 104.

Note that as it is obvious from the system configuration in FIG. 16, the call information management apparatus 1600 may include the microburst detection apparatus 121 and may be configured integrally therewith.

### Fourth Embodiment

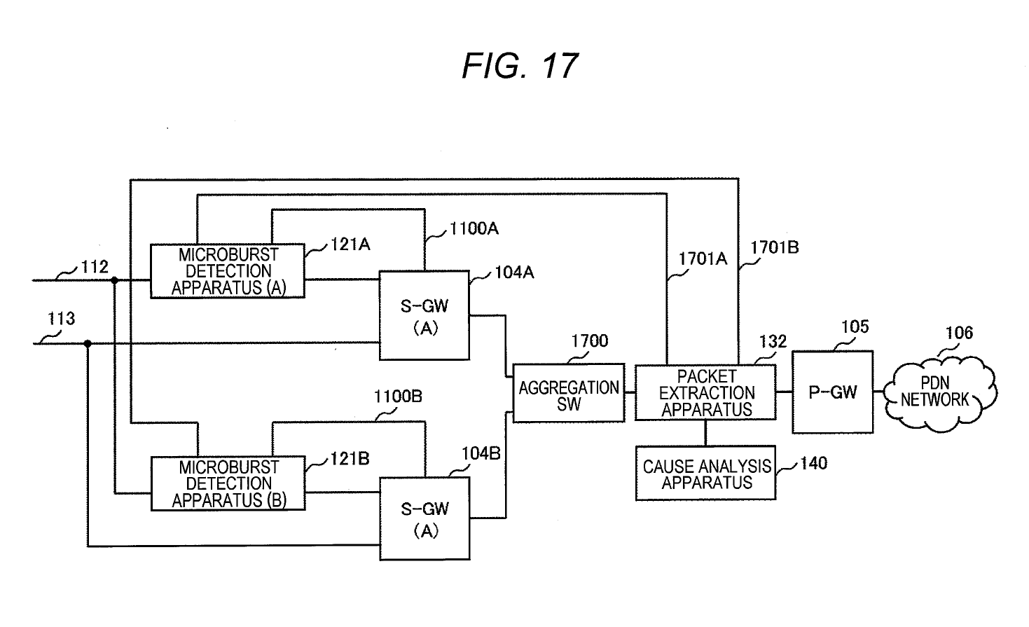

In FIG. 17, a configuration of an LTE system of the present embodiment is illustrated in comparison with the system configuration of the second embodiment illustrated in FIG. 11. However, as it will be described later, an operation is different. A configuration of the LTE system of the present embodiment includes a plurality of S-GWs (S-GW (A) 104A and S-GW (B) 104B). The S-GWs 104A and 104B are aggregated by an aggregation SW 1700 and connected to a P-GW 105. Here, a case where a protocol of a C-Plane of a communication path called S5/S8 between the S-GWs 104A and 104B and the P-GW 105 is GTPv2-C will be described as an example.

As it is obvious from FIG. 17, in the present embodiment, one packet detection apparatus 132 is placed for a plurality of microburst detection apparatuses (121A and 121B).

To detect a microburst of a Modify Bearer Request (219) moving to the S-GW (A) 104A in the S11 (112), the microburst detection apparatus (A) 121A is placed. To detect a microburst of a Modify Bearer Request (219) moving to the S-GW (B) 104B, the microburst detection apparatus (B) 121B is placed. Also, a packet extraction apparatus 132 is placed to the communication path S5/S8 between the aggregation SW 1700, which aggregates the S-GW (A) 104A and the S-GW (B) 104B, and the P-GW 105. Both of a U-Plane packet which flows in the S-GW (A) 104A and a U-Plane packet which flows in the S-GW (B) 104B flow between the aggregation SW 1700 and the P-GW 105. Thus, placing one packet extraction apparatus is enough. On the other hand, it is useless to place one microburst detection apparatus between the aggregation SW 1700 and the P-GW 105. It is because a microburst of the Modify Bearer Request (219) which reaches the S-GW (A) 104A or the S-GW (B) 104B may not reach the P-GW 105 in a burst-state after being processed by the S-GW (A) 104A or the S-GW (B) 104B.

The microburst detection apparatus (A) 121A and the microburst detection apparatus (B) 121B are connected, respectively through communication paths 1701A and 1701B, to the packet extraction apparatus 132. The packet extraction apparatus 132 is connected to a cause analysis apparatus 141.

Also, the microburst detection apparatus (A) 121A and the microburst detection apparatus (B) 121B are respectively connected to the S-GW (A) 104A and the S-GW (B) 104B through interfaces 1100A and 1100B in order to acquire call information correspondence tables.

Similarly to the second embodiment, other than the interfaces 1100A and 1100B being respectively provided to the S-GW#1 S-GW (A) 104A and S-GW (B) 104B, it is not necessary to change an original configuration of the LTE system.

In the following, an operation of when a microburst of the Modify Bearer Request reaches the S-GW (A) 104A will be described in comparison with the other embodiments. An operation of when a microburst of the Modify Bearer Request reaches the S-GW (B) 104B is in a similar manner.

The contents of items illustrated in FIG. 5 of the first embodiment are preset into the microburst detection apparatus (A) 121A. In respect to the preset contents, corresponding to a Modify Bearer Request (219) in a message type 501, a count cycle 502 and a microburst detection threshold 503 may be similar to those in FIG. 5. However, to a U-Plane call information extraction method, the following two items are preset. One is to extract a destination IP address and a destination TEID from a packet of the Modify Bearer Request (219). The other is to extract an S5/S8-U SGW F-TEID corresponding to the extracted destination IP address and destination TEID from a call information correspondence table when a microburst is determined. The S5/S8-U SGW F-TEID is an identifier which is a set of an IP address of the SGW (A) 104A and a Downlink TEID delivered from the SGW (A) 104A to the P-GW 105.

With this, the microburst detection apparatus (A) 121A extracts a destination IP address of an IP header and a destination TEID of a GTPv2-C header of a packet including the Modify Bearer Request (219) as the message type. Also, the microburst detection apparatus (A) 121A determines a microburst in a case where the number of counted packets of the Modify Bearer Request (219) in the count cycle 502 is equal to or greater than a set value of the microburst detection threshold 503. Moreover, when determining the microburst, the microburst detection apparatus (A) 121A extracts an S5/S8-U SGW F-TEID corresponding to the extracted destination IP address and destination TEID from the call information correspondence table.

Note that when executing, as an original operation, a call control sequence such as Initial Attach, Tracking Area Update with S-GW change, Handover with S-GW change, Dedicated Bearer Activation, and Dedicated Bearer Deactivation, the S-GW (A) 104A executes processing to associate an “F-TEID for C-Plane delivered to MME” with the “S5/S8-U SGW F-TEID”.

Although it is not illustrated, in respect to the call information correspondence table of the present embodiment, the SGW (A) 104A stores the “F-TEID for C-Plane delivered to MME” associated with the “S5/S8-U SGW F-TEID”.

When the Modify Bearer Request (219) reaches the microburst detection apparatus (A) 121A, the microburst detection apparatus (A) 121A follows the setting and extracts a destination IP address and a destination TEID from a packet of the Modify Bearer Request (219) while counting the number of packets. Other than the processing in S1303, the operation of the microburst detection apparatus (A) 121A is similar to that in FIG. 13 of the second embodiment. In S1303 in FIG. 13, the microburst detection apparatus 121 extracts an S1-U SGW F-TEID (1402) and transmits a packet extraction instruction including the extracted S1-U SGW F-TEID to the packet extraction apparatus 131. However, in the present embodiment, the microburst detection apparatus (A) 121A extracts an S5/S8-U SGW F-TEID and transmits a packet extraction instruction including the extracted S5/S8-U SGW F-TEID to the packet extraction apparatus 132.

An operation of the packet extraction apparatus 132 which has received the packet extraction instruction is similar to the operation of the packet extraction apparatus 130 of the first embodiment illustrated in FIG. 8. In S801 and S803 in FIG. 8, a U-Plane packet which matches an S1 eNodeB F-TEID included in a packet extraction instruction is detected. However, the packet extraction apparatus 132 of the present embodiment detects a U-Plane packet which matches an S5/S8-U SGW F-TEID included in a packet extraction instruction. An operation, which is accompanied with reception of a U-Plane packet or the like from the packet extraction apparatus 132, of the cause analysis apparatus 140 is similar to the operation illustrated in FIG. 9 of the first embodiment.

As described above, although it is necessary to place a plurality of microburst detection apparatuses in response to a plurality of S-GWs, by placing one packet extraction apparatus and one cause analysis apparatus, a maintainer can recognize a service/application which is a cause of microburst occurrence and ask an operator providing the service/application for an improvement such as spreading timing of communication occurrence, similarly to the other embodiments described above.

### Fifth Embodiment

The present embodiment is a modified example of the fourth embodiment. In the fourth embodiment, the interface for acquiring a call information correspondence table is connected to the S-GW (A) 104A and the S-GW (B) 104B. In the fourth embodiment, the S-GW (A) 104A and the S-GW (B) 104B create the call information correspondence tables by the original operations thereof, and respectively output the call information correspondence tables to the microburst detection apparatus (A) 121A and the microburst detection apparatus (B) 121B in response to requests from the microburst detection apparatus (A) 121A and the microburst detection apparatus (B) 121B. In the present embodiment, a call information management apparatus is introduced on the assumption of a case where a microburst detection apparatus (A) 121A and a microburst detection apparatus (B) 121B cannot receive call information correspondence tables respectively from an S-GW (A) 104A and an S-GW (B) 104B.

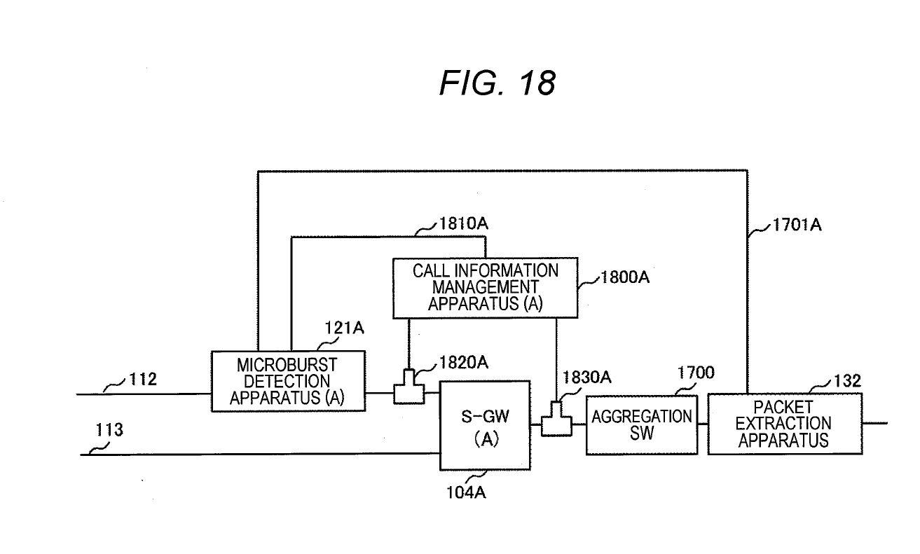

In FIG. 18, a system configuration view of an LTE system of the present embodiment is illustrated with a point different from the embodiment illustrated in FIG. 17 being illustrated mainly. FIG. 18 is a view illustrating a configuration along a path from the microburst detection apparatus (A) 121A to the packet extraction apparatus 132 in FIG. 17. A configuration along a path from the microburst detection apparatus (B) 121B to the packet extraction apparatus 132 is in a similar manner, and thus, the configuration thereof is not illustrated or described. As illustrated, a microburst detection apparatus (A) 121A acquires a call information table from a call information management apparatus (A) 1800A through an interface 1810A.

The call information management apparatus (A) 1800A includes an interface 1820A to monitor a C-Plane packet in S11 (112) of an S-GW (A) 104A and an interface 1830A to monitor a C-Plane packet in a communication path S5/S8 from the S-GW (A) 104A to an aggregation SW 1700. A point different from the fourth embodiment is to provide such a call information management apparatus (A) 1800A.

The call information management apparatus (A) 1800A monitors, through the interface 1820A and the interface 1830A, a message of the S11 (112) and a message of the S5/S8 during a call control sequence such as Initial Attach, Tracking Area Update with S-GW change, Handover with S-GW change, Dedicated Bearer Activation, and Dedicated Bearer Deactivation, and associates an F-TEID for a C-Plane delivered from the S-GW (A) 104A to an MME 103 with an S5/S8-U SGW F-TEID delivered from the S-GW (A) 104A to a P-GW 105.

This association will be described with processing during the Initial Attach as an example. Here, detail description of the Initial Attach is omitted.

By monitoring an Uplink C-Plane packet of the S11 (112) of the S-GW (A) 104A through the interface 1820A and analyzing the Uplink C-Plane packet, the call information management apparatus (A) 1800A responds to reception of a packet including a Create Session Request as a message type and detects the Initial Attach. Information included in the packet of the Create Session Request is stored in the following manner. *A subscriber identifier called an IMSI is stored into a memory 1 (not illustrated, hereinafter each memory is not illustrated) of the call information management apparatus (A) 1800A. *Information which is called a Sender F-TEID for Control Plane and is for telling an F-TEID for a C-Plane delivered from a sender side to a receiver in a destination of GTPv2-C, that is, here, an F-TEID delivered from the MME 103 is stored into a memory 2. *An F-TEID for a C-Plane of the PGW 105, which is called a PGW S5/S8 Address for Control Plane or PMIP, is stored into a memory 3. Although an IP address of the PGW 105 is stored in a Create Session Request of the Initial Attach, a TEID is 0.

Next, when detecting, from the Uplink C-Plane packet of the S5/S8 of the S-GW (A) 104A through the interface 1830A, a packet which includes a destination IP address equal to an IP address in the PGW S5/S8 Address for Control Plane or PMIP stored in the memory 3, a Create Session Request as a message type, and an IMSI equal to the IMSI stored in the memory 1, the call information management apparatus (A) 1800A stores the information included in the packet in the following manner. *The Sender F-TEID for Control Plane, that is, here, the F-TEID for a C-Plane delivered from the S-GW (A) 104A to the P-GW 105 is stored into a memory 4. *The S5/S8-U SGW F-TEID is stored into a memory 5.

Next, the call information management apparatus (A) 1800A detects, from a Downlink C-Plane packet of the S5/S8 of the S-GW (A) 104A through the interface 1830A, a packet which includes a TEID of the GTPv2-C header equal to a TEID in the Sender F-TEID for Control Plane stored in the memory 4 and the Create Session Response as the message type. However, since there is not information stored into the memory here, the processing may be omitted.

Next, the call information management apparatus (A) 1800A detects, through the interface 1820A, a packet, which includes a TEID of the GTPv2-C header equal to a TEID in the Sender F-TEID for Control Plane stored in the memory 2 and the Create Session Response as the message type, from the Downlink C-Plane packet of the S11 (112) of the S-GW (A) 104A. The information included in the packet is stored in the following manner. *The Sender F-TEID for Control Plane is stored into a memory 6.

The data in the memory 6 and the data in the memory 5 are respectively associated with an “F-TEID for C-Plane delivered to MME” and an “S5/S8-U SGW F-TEID” on the call information correspondence table and managed.

Although description of other operations in the call control sequence is omitted, a Sender F-TEID for Control Plane in an Uplink message and a destination IP address of an IP header and a TEID of a GTPv2-C header in a Downlink message packet of the S11 (112) are checked, and the Uplink message and the Downlink message of the S11 (112) are associated with each other in a similar manner. Also, a Sender F-TEID for Control Plane in an Uplink message and a destination IP address of an IP header and a TEID of a GTPv2-C header in a Downlink message packet of the communication path S5/S8 are checked, and the Uplink message and the Downlink message of the communication path S5/S8 are associated with each other. Also, an IMSI, a PGW S5/S8 Address for Control Plane or PMIP, and the like can be checked and a message of the S11 (112) and a message of the communication path S5/S8 can be associated with each other. An S5/S8-U SGW F-TEID in the Uplink message of the communication path S5/S8 and a Sender F-TEID for Control Plane in the Downlink message of the S11 (112) can be extracted and respectively associated with the “F-TEID for C-Plane delivered to MME” and the “S5/S8-U SGW F-TEID” on the call information correspondence table and managed.

What has been described above is a unique operation of the present embodiment and an operation, description of which is omitted, is in a manner similar to that of the fourth embodiment.

In the following, configuration views and operations of a microburst detection apparatus 120, a packet extraction apparatus 130, a cause analysis apparatus 140, and a call information management apparatus which have been described in each embodiment will be briefly illustrated. Note that a reference sign of each apparatus (such as microburst detection apparatus 120) also represents the apparatus. In a configuration view, a modification in each embodiment is also included and an operation of the apparatus is described.

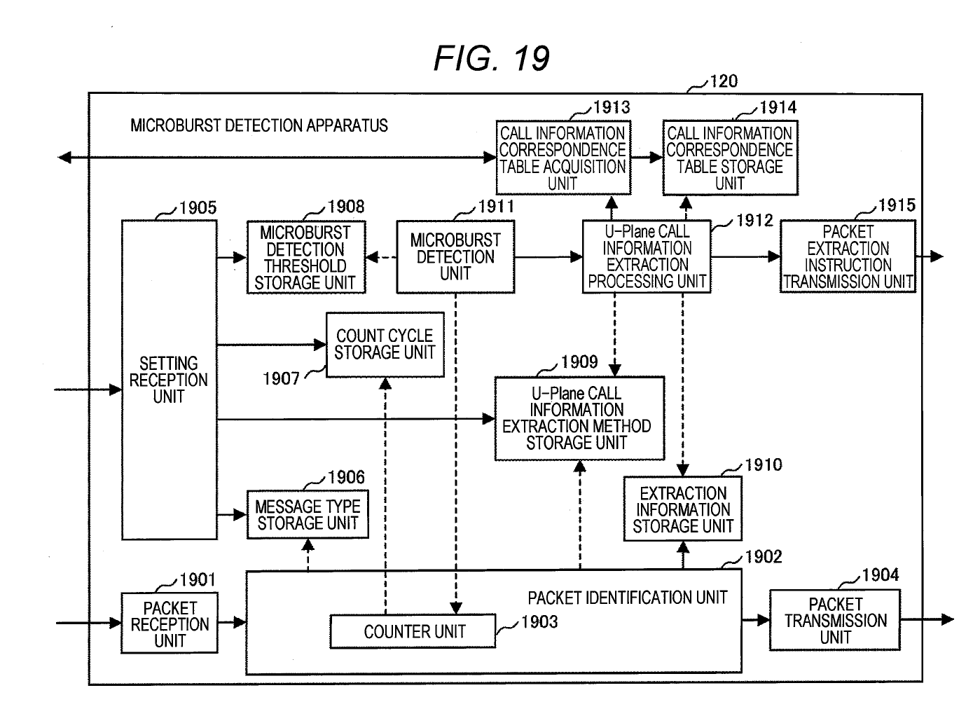

In FIG. 19, a configuration view of the microburst detection apparatus 120 is illustrated. A setting reception unit 1905 receives and stores a message type, a count cycle, a microburst detection threshold, and a U-Plane call information extraction method, which are contents set by a maintainer, into a message type storage unit 1906, a count cycle storage unit 1907, a microburst detection threshold storage unit 1908, and a U-Plane call information extraction method storage unit 1909, respectively.

A packet reception unit 1901 receives a packet and outputs the received packet to a packet identification unit 1902. When the packet input from the packet reception unit 1901 is a packet of a message type stored in the message type storage unit 1906, the packet identification unit 1902 counts the number of packets by a counter unit 1903 and extracts, based on an extraction method stored in the U-Plane call information extraction method storage unit 1909, information in the packet including the matching message type and stores the extracted information into the extraction information storage unit 1910. The counter unit 1903 clears a counter in a cycle stored in the count cycle storage unit 1907. Also, the packet identification unit 1902 outputs a packet to a packet transmission unit 1904. The packet transmission unit 1904 transmits the input packet to a communication apparatus (for example, S-GW 104 in a case of FIG. 3) in the following stage.

The microburst detection unit 1911 refers to the counter unit 1903 and determines that a packet of a matching message type is a microburst when a counter value becomes equal to or greater than a microburst detection threshold stored in the microburst detection threshold storage unit 1908 within a cycle stored in the count cycle storage unit 1907.

In a case of a microburst, a U-Plane call information extraction processing unit 1912 refers to the U-Plane call information extraction method storage unit 1909 and instructs a call information correspondence table acquisition unit 1913 to acquire a call information correspondence table, when necessary (according to operation of the described embodiment). The call information correspondence table acquisition unit 1913 acquires the call information correspondence table and stores the acquired call information correspondence table into a call information correspondence table storage unit 1914.

A U-Plane call information extraction processing unit 1212 refers to the extraction information storage unit 1910 and the call information correspondence table storage unit 1914. Then, based on the extraction method stored in the U-Plane call information extraction method storage unit 1909, the U-Plane call information extraction processing unit 1212 sets the information stored in the extraction information storage unit 1910 as U-Plane call information or extracts U-Plane call information from the call information correspondence table stored in the call information correspondence table storage unit 1914 based on the information stored in the extraction information storage unit 1910, and outputs the U-Plane call information to a packet extraction instruction transmission unit 1915. The packet extraction instruction transmission unit 1915 transmits, to the packet extraction apparatus 130, a packet extraction instruction including U-Plane call information input from the U-Plane call information extraction processing unit 1912.

Note that in a case, such as the first embodiment, where a call information correspondence table is not necessary, the call information correspondence table acquisition unit 1913 and the call information correspondence table storage unit 1914 can be omitted.

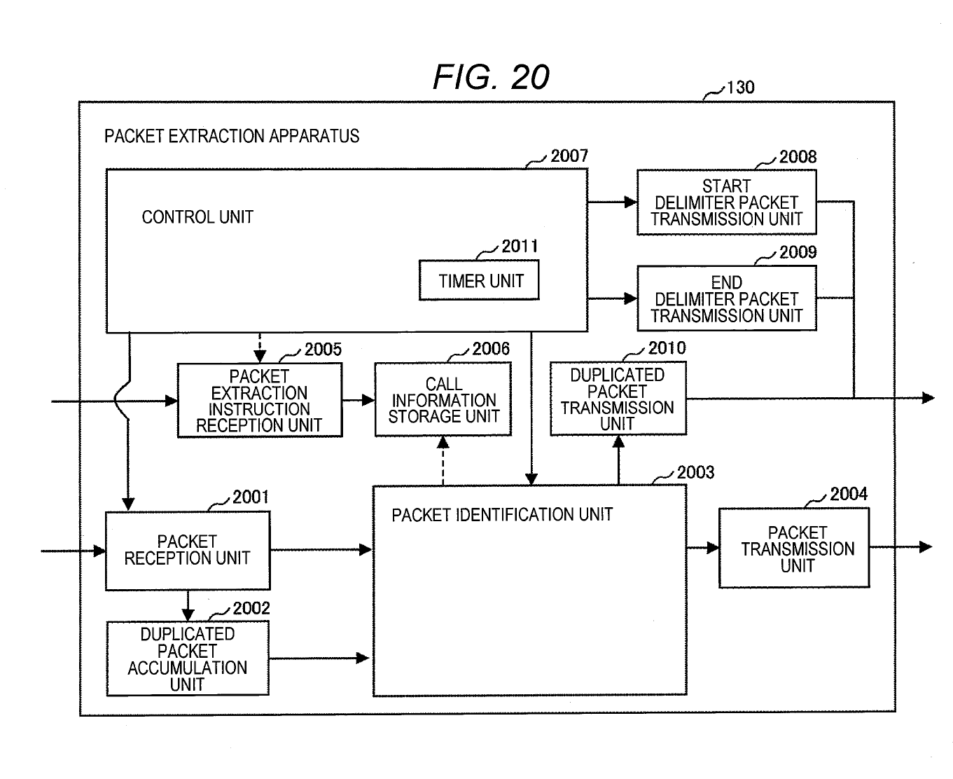

In FIG. 20, a configuration view of the packet extraction apparatus 130 is illustrated. A packet reception unit 2001 receives a U-Plane packet and outputs the received U-Plane packet to a packet identification unit 2003. Also, according to an instruction from a control unit 2007 (for example, second embodiment), the packet reception unit 2001 duplicates the received U-Plane packet and accumulates the duplicated packet in a duplicated packet accumulation unit 2002.

A packet extraction instruction reception unit 2005 receives a packet extraction instruction from the microburst detection apparatus 120 and stores U-Plane call information included therein into a call information storage unit 2006. In response to the packet extraction instruction, the control unit 2007 controls a start delimiter packet transmission unit 2008 to transmit a start delimiter packet to the cause analysis apparatus 140 and instructs the packet identification unit 2003 to start packet extraction.

The packet identification unit 2003 transmits the U-Plane packet acquired from the packet reception unit 2001 to a communication apparatus (such as S-GW 104 in a case of FIG. 3) in the following stage through a packet transmission unit 2004. Also, when receiving an instruction to start packet extraction, the packet identification unit 2003 checks the packet input from the duplicated packet accumulation unit 2002 or the packet reception unit 2001 with the call information stored in the call information storage unit 2006 and duplicates the packet which matches the call information. Then, the packet identification unit 2003 transmits the duplicated packet to the cause analysis apparatus 140 through the duplicated packet transmission unit 2010. When a predetermined period of time has passed according to a timer unit 2011, the control unit 2007 outputs an instruction to the packet identification unit 2003 to end the packet extraction and controls an end delimiter packet transmission unit 2009 to transmit an end delimiter packet to the cause analysis apparatus 140.

Note that in a case where a U-Plane packet to be extracted reaches the packet reception unit 2001 after the packet extraction instruction reception unit 2005 has received the packet extraction instruction (such as a case of first embodiment), the duplicated packet accumulation unit 2002 is omitted and the packet identification unit 2003 acquires the packet from the packet reception unit 2001.

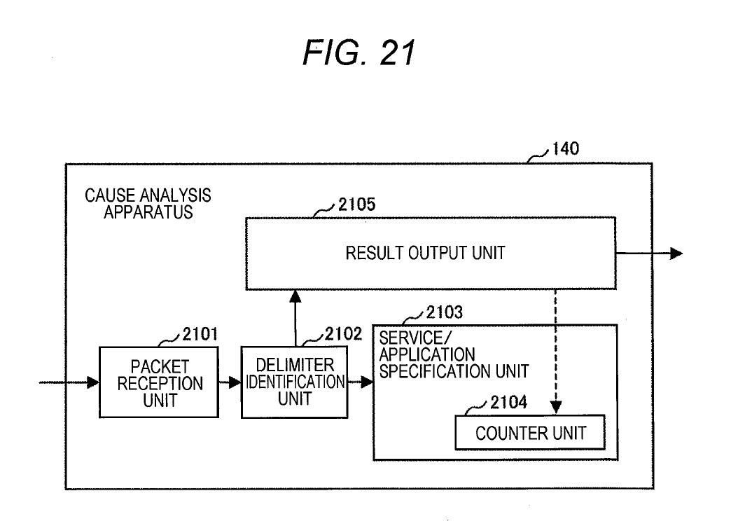

In FIG. 21, a configuration view of the cause analysis apparatus 140 is illustrated. A packet reception unit 2101 receives a packet from the packet extraction apparatus 130. When identifying that the received packet is a start delimiter packet, a delimiter identification unit 2102 outputs a U-Plane packet which is received thereafter to a service/application specification unit 2103. The service/application specification unit 2103 analyzes the inside of a payload of an application layer of the packet and specifies which service/application the data belongs to. Then, the service/application specification unit 2103 increments a counter of a counter unit 2104 for each specified service/application. In response to the identification, by the delimiter identification unit 2102, indicating that the received packet is an end delimiter packet, a result output unit 2105 displays a count value of the counter unit 2104 in a chart of a graph on a display apparatus (not illustrated).

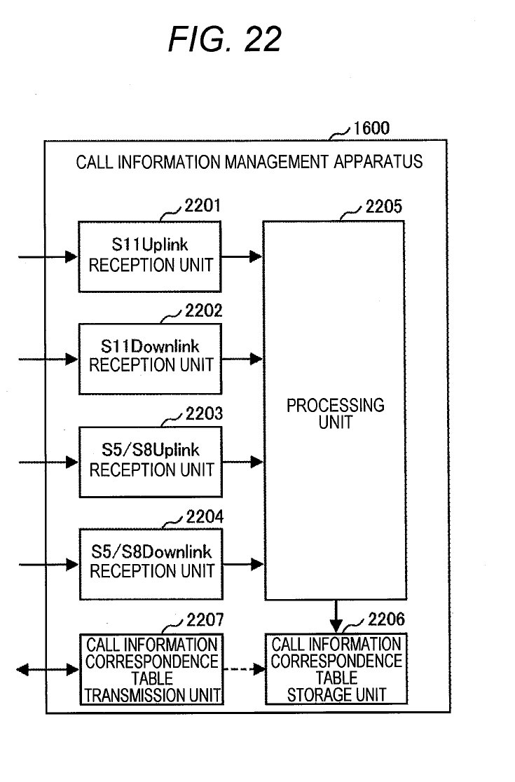

In FIG. 22, a configuration view of a call information management apparatus 1600 is illustrated. An S11Uplink reception unit 2201 receives a C-Plane packet of an S11Uplink. An S11Downlink reception unit 2202 receives a C-Plane packet of an S11Downlink. An S5/S8Uplink reception unit 2203 receives a C-Plane packet of an S5/S8Uplink. An S5/S8Downlink reception unit 2204 receives a C-Plane packet of an S5/S8Downlink. A processing unit 2205 analyzes each of the C-Plane packets received in 2201 to 2204, generates a call information correspondence table, and stores the generated table into a call information correspondence table storage unit 2206. A call information correspondence table transmission unit 2207 responds to a request from the microburst detection apparatus 120 and transmits the call information correspondence table stored in the call information correspondence table storage unit 2206 to the microburst detection apparatus 120.

In summary, the present embodiment described above is an LTE system including a microburst detection apparatus, a packet extraction apparatus, and a cause analysis apparatus, and each of the apparatuses operates in the following manner. The microburst detection apparatus detects a microburst of a control plane packet and extracts, from the control plane packet which forms the detected microburst, call information for identifying call of a data plane. The packet extraction apparatus extracts a data plane packet corresponding to the call information extracted by the microburst detection apparatus. The cause analysis apparatus analyzes a payload of an application layer of the data plane packet extracted by the packet extraction apparatus and specifies a service/application which causes microburst occurrence. Then, the cause analysis apparatus counts the number of data plane packets in response to the specified service/application and displays the counted number of packets associated with the specified service/application.

With such a configuration above, it is possible to extract and analyze a data plane packet corresponding to a microburst, and thus, it is possible to specify a cause of microburst occurrence.

What is claimed is:

1. A system for specifying a cause of microburst occurrence, comprising:
a microburst detection apparatus configured to detect a microburst of a control plane packet and to extract, from the control plane packet which forms the detected microburst, call information for identifying call of a data plane;
a packet extraction apparatus configured to extract a data plane packet corresponding to the call information extracted by the microburst detection apparatus; and
a cause analysis apparatus configured to analyze a payload of an application layer of the data plane packet extracted by the packet extraction apparatus, specify a service/application which causes occurrence of the microburst, count the number of data plane packets in response to the specified service/application, and display the counted number of packets associated with the specified service/application.

2. The system for specifying a cause of microburst occurrence according to claim 1, wherein the microburst detection apparatus is included in a communication path in which the control plane packet flows and the packet extraction apparatus is included in a communication path in which the data plane packet flows,
the microburst detection apparatus counts the number of received control plane packets including a predetermined type of call control message in a cycle of predetermined duration and determines that the microburst is a microburst of the control plane packet including the predetermined type of call control message when the counted number of received control plane packets in one cycle is equal to or greater than a predetermined threshold, and
the microburst detection apparatus responds to determination of the microburst and transmits a packet extraction instruction including the extracted call information to the packet extraction apparatus.

3. The system for specifying a cause of microburst occurrence according to claim 2, wherein the communication path in which the control plane packet flows is a communication path S11 of an LTE system and the communication path in which the data plane packet flows is a communication path S1-U or S5/S8 of the LTE system.

4. The system for specifying a cause of microburst occurrence according to claim 3, wherein the microburst detection apparatus is connected to a communication apparatus of the LTE system,
the microburst detection apparatus acquires, from the communication apparatus, a correspondence table, between the call information and other call information, included in the communication apparatus and extracts the other call information corresponding to the call information from the correspondence table, and
the packet extraction apparatus extracts the data plane packet corresponding to the other call information extracted by the microburst detection apparatus.

5. The system for specifying a cause of microburst occurrence according to claim 3, wherein the microburst detection apparatus is connected to a call information management apparatus configured to generate a correspondence table between the call information and other call information,
the microburst detection apparatus acquires the correspondence table from the call information management apparatus and extracts the other call information corresponding to the call information from the correspondence table, and
the packet extraction apparatus extracts the data plane packet corresponding to the other call information extracted by the microburst detection apparatus.

6. A method for specifying a cause of microburst occurrence using a microburst detection apparatus, a packet extraction apparatus, and a cause analysis apparatus, the method comprising:
detecting a microburst of a control plane packet and extracting call information for identifying call of a data plane from the control plane packet which forms the detected microburst, the detecting and the extracting being performed by the microburst detection apparatus;
extracting a data plane packet corresponding to the call information extracted by the microburst detection apparatus, the extracting being performed by the packet extraction apparatus; and
analyzing a payload of an application layer of the data plane packet extracted by the packet extraction apparatus, specifying a service/application which causes occurrence of the microburst, counting the number of data plane packets in response to the specified service/application, and displaying the counted number of packets associated with the specified service/application, the analyzing, the specifying, the counting, and the displaying being performed by the cause analysis apparatus.

7. The method for specifying a cause of microburst occurrence according to claim 6, wherein the microburst detection apparatus is included in a communication path in which the control plane packet flows and the packet extraction apparatus is included in a communication path in which the data plane packet flows,
the microburst detection apparatus counts the number of received control plane packets including a predetermined type of call control message in a cycle of predetermined duration and determines that the microburst is a microburst of the control plane packet including the predetermined type of call control message when the counted number of received control plane packets in one cycle is equal to or greater than a predetermined threshold, and
the microburst detection apparatus responds to determination of the microburst and transmits a packet extraction instruction including the extracted call information to the packet extraction apparatus.

8. The method for specifying a cause of microburst occurrence according to claim 7, wherein the communication path in which the control plane packet flows is a communication path S11 of an LTE system and the communication path in which the data plane packet flows is a communication path S1-U or S5/S8 of the LTE system.

9. The method for specifying a cause of microburst occurrence according to claim 8, wherein the microburst detection apparatus is connected to a communication apparatus of the LTE system,
the microburst detection apparatus acquires, from the communication apparatus, a correspondence table, between the call information and other call information, included in the communication apparatus and extracts the other call information corresponding to the call information from the correspondence table, and
the packet extraction apparatus extracts the data plane packet corresponding to the other call information extracted by the microburst detection apparatus.

10. The method for specifying a cause of microburst occurrence according to claim 8, wherein the microburst detection apparatus is connected to a call information management apparatus configured to generate a correspondence table between the call information and other call information,
the microburst detection apparatus acquires the correspondence table from the call information management apparatus and extracts the other call information corresponding to the call information from the correspondence table, and
the packet extraction apparatus extracts the data plane packet corresponding to the other call information extracted by the microburst detection apparatus.
